(19) United States
(12) Patent Application Publication
(10) Pub. No.: US 2015/0293790 A1
(43) Pub. Date: Oct. 15, 2015

(54) METHOD AND SYSTEM FOR DRIVING VIRTUAL MACHINE

(71) Applicant: ELECTRONICS AND TELECOMMUNICATIONS RESEARCH INSTITUTE, Daejeon (KR)

(72) Inventors: Soo Young KIM, Cheongju-Si (KR); Tae Ho KIM, Gunpo-Si (KR); Chae Deok LIM, Daejeon (KR)

(73) Assignee: ELECTRONICS AND TELECOMMUNICATIONS RESEARCH INSTITUTE, Daejeon (KR)

(21) Appl. No.: 14/675,289

(22) Filed: Mar. 31, 2015

(30) Foreign Application Priority Data
Apr. 9, 2014 (KR) 10-2014-0042421

(51) Int. Cl. G06F 9/50; G06F 9/455

(52) U.S. Cl. CPC G06F 9/5016; G06F 9/45558; G06F 2009/45583

(57) ABSTRACT

Provided herein a method for driving a virtual machine, the method including providing a plurality of virtual machines and a virtual machine monitor configured to manage the plurality of virtual machines; generating, by the plurality of virtual machines, memory management information, that is information on memory being used by the plurality of virtual machines; and determining, by the virtual machine monitor, whether or not a virtual machine is a victim virtual machine from which memory needs to be retrieved or whether or not the virtual machine is a beneficiary virtual machine where memory needs to be allocated, based on the memory management information.

### CROSS-REFERENCE TO RELATED APPLICATION

The present application claims priority to Korean patent application number 10-2014-0042421, filed on Apr. 9, 2014, the entire disclosure of which is incorporated herein in its entirety by reference.

### BACKGROUND

1. Field of Invention

Various embodiments of the present invention relate to a method and system for driving a virtual machine, and more particularly, to a method and system for driving a virtual machine related to memory reclaiming and dynamic reallocation.

2. Description of Related Art

With the rapid development of hardware in recent years, virtual machine monitor or hypervisor technology for creating, managing and controlling a plurality of virtual machines has been introduced and widely used so that a plurality of operating systems can be simultaneously executed in a single system.

A virtual machine monitor allocates physical memory that is one of the system resources that it manages to a plurality of virtual machines so that the allocated memory can be used by a guest OS operating in the virtual machines. The virtual machine monitor uses either the static allocation policy wherein a fixed amount of memory is allocated to virtual machines, or the dynamic reallocation policy wherein a demand paging method is used to take a memory from a guest OS at the virtual machine monitor level and allocate the memory to another guest OS that needs more memory.

When using the dynamic reallocation policy, however, all the information on the memory accessed by each virtual machine is tracked at the virtual machine monitor level, thereby deteriorating the overall performance of the system. Furthermore, since some of the recent CPUs support hardware assisted virtualization functions, in many cases, it may not be easy for a virtual machine monitor to track information on the accessed memory due to the characteristics of the hardware (for example, Intel VT-x, AMD-V, ARM-VE).

Not only that, when a virtual machine monitor estimates information on the memory accessed by each virtual machine, the estimates may not be accurate. Due to this inaccuracy of estimation, the entire system performance may be deteriorated.

### SUMMARY

Various embodiments of the present invention are directed to a method and system for driving a virtual machine using the dynamic reallocation policy based on memory management information received from inside the virtual machine.

Furthermore, various embodiments of the present invention are directed to a method and system for driving a virtual machine wherein a virtual machine monitor can easily obtain memory management information regardless of the characteristics of hardware.

One embodiment of the present invention provides a method for driving a virtual machine, the method including providing a plurality of virtual machines and a virtual machine monitor configured to manage the plurality of virtual machines; generating, by the plurality of virtual machines, memory management information, that is information on memory being used by the plurality of virtual machines; and determining, by the virtual machine monitor, whether or not a virtual machine is a victim virtual machine from which memory needs to be retrieved or whether or not the virtual machine is a beneficiary virtual machine where memory needs to be allocated, based on the memory management information.

Another embodiment of the present invention provides a system for driving a virtual machine, the system including a plurality virtual machines each having a virtual machine information manager; and a virtual machine monitor configured to manage the plurality of virtual machines and having a virtual machine selector, wherein memory management information on the memory used by each virtual machine is generated by the virtual machine information manager, and the virtual machine selector determines whether or not a virtual machine is a victim virtual machine from which memory needs to be retrieved or whether or not the virtual machine is a beneficiary virtual machine to which memory needs to be allocated.

Various aforementioned embodiments of the present invention has an effect of providing a method and system for driving a virtual machine using the dynamic reallocation policy based on memory management information received from inside the virtual machine.

Furthermore, various aforementioned embodiments of the present invention has an effect of providing a method and system for driving a virtual machine wherein a virtual machine monitor can easily obtain memory management information regardless of the characteristics of hardware.

### BRIEF DESCRIPTION OF THE DRAWINGS

The above and other features and advantages of the present invention will become more apparent to those of ordinary skill in the art by describing in detail exemplary embodiments with reference to the attached drawings in which:

FIG. 1 is a block diagram illustrating a system for driving a virtual machine according to an embodiment of the present invention;

FIG. 2 is a flowchart illustrating a method for driving a virtual machine according to an embodiment of the present invention;

FIG. 3 is a flowchart illustrating a method for driving a virtual machine according to another embodiment of the present invention;

FIG. 4 is a view illustrating a step of determining whether or not a virtual machine is a victim virtual machine or a beneficial virtual machine in a method for driving a virtual machine according to another embodiment of the present invention; and

FIGS. 5 to 8 are views illustrating mapping of a virtual address, pseudo-physical address, and physical address when using a method for driving a virtual machine according to another embodiment of the present invention.

### DETAILED DESCRIPTION

The present invention will be described more fully hereinafter with reference to the accompanying drawings, in which embodiments of the invention are shown. This invention may, however, be embodied in different forms and should not be construed as limited to the embodiments set forth herein.

Rather, these embodiments are provided so that this disclosure will be thorough and complete, and will fully convey the scope of the present invention to those skilled in the art. In the drawings, a thicknesses and a distance of components are exaggerated compared to an actual physical thickness and interval for convenience of illustration. In the following description, detailed explanation of known related functions and constitutions may be omitted to avoid unnecessarily obscuring the subject manner of the present invention. Like reference numerals refer to like elements throughout the specification and drawings.

In this specification, a singular form may include a plural form as long as it is not specifically mentioned in a sentence. Furthermore, ‘include/comprise’ or ‘including/comprising’ used in the specification represents that one or more components, steps, operations, and elements exist or are added.

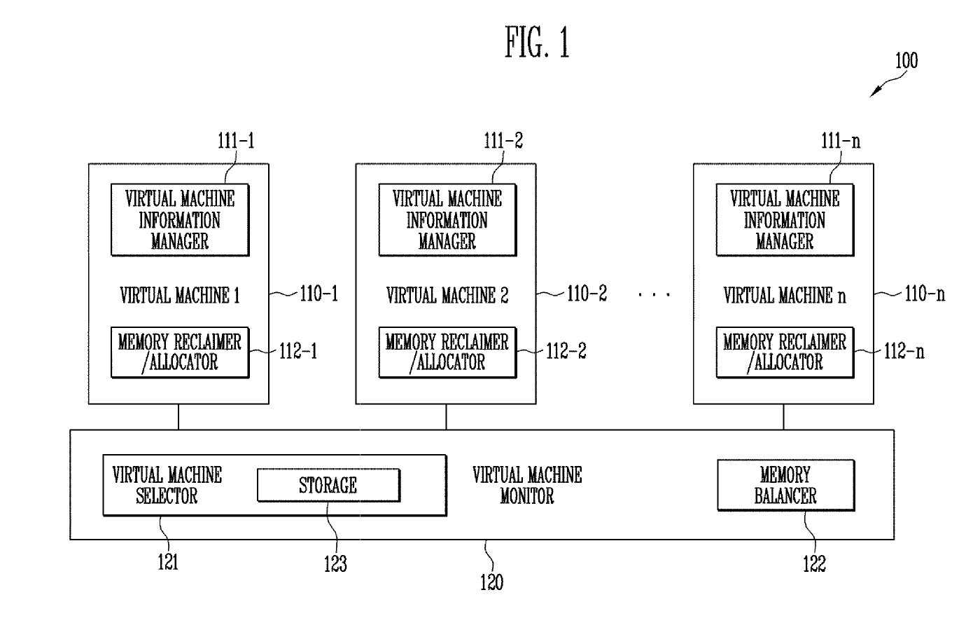

FIG. 1 is a block diagram illustrating a system for driving a virtual machine according to an embodiment of the present invention. Referring to FIG. 1, a system for driving a virtual machine 100 includes virtual machine 1 to virtual machine n, 110-1 to 110-n, and a virtual machine monitor 120 configured to manage the n virtual machines, 110-1 to 110-n. Each of the virtual machines, 110-1 to 110-n, includes each of virtual machine information managers, 111-1 to 111-n, and each of memory reclaimers/allocators, 112-1 to 112-n, respectively, and the virtual machine monitor 120 includes a virtual machine selector 121 and a memory balancer 122. In FIG. 1, a storage 123 is included in the virtual machine selector 121, but the storage 123 may be included in the virtual machine monitor 120 instead.

Each of the virtual machines, 110-1 to 110-n, may be operated by its individual operating system, and may perform its individual process, and the virtual machine monitor 120 may create/manage the virtual machines, 110-1 to 110-n, and allocate memory to the virtual machines, 110-1 to 110-n, allowing the virtual machines, 110-1 to 110-n, to operate.

The virtual machine information managers, 111-1 to 111-n, transmit memory management information to the virtual machine selector 121. The memory management information is information on the memory being used by the virtual machines, 110-1 to 110-n. This information desirably includes at least one of a length of an allocated pseudo-physical address, usage rate of the allocated pseudo-physical address, capacity for performing unmapping (reclaiming), size of a working set, and space usage rate of a swap device. The memory reclaimers/allocators, 112-1 to 112-n, may transmit a pseudo-physical address to the memory balancer 122, or receive the length of a particular memory from the memory balancer 122.

The virtual machine selector 121 determines whether or not there is a victim virtual machine or a beneficial virtual machine based on memory management information received from the virtual machine information managers, 111-1 to 111-n, included in the n virtual machines, 110-1 to 110-n, respectively. Since the virtual machine selector 121 receives memory management information from the virtual machine information managers, 111-1 to 111-n, included in the virtual machines, 110-1 to 110-n, respectively, the virtual machine monitor can easily obtain the memory management information regardless of hardware characteristics. The virtual machine selector 121 may receive the memory management information from either the virtual machine information managers, 111-1 to 111-n, or from the virtual machines, 110-1 to 110-n.

Certain conditions being satisfied, the memory balancer 122 may receive a pseudo-physical address that can be unmapped (pseudo-physical address from which memory can be retrieved) or a pseudo-physical address that can be mapped (pseudo-physical address where memory can be allocated) from the memory reclaimers/allocators, 112-1 to 112-n, and when certain conditions are satisfied, the memory balancer 122 may transmit capacity capable of unmapping the pseudo-physical address. In the case where the memory balancer 122 receives a pseudo-physical address that can be unmapped, the memory balancer 122 unmaps a physical address from the pseudo-physical address. Furthermore, in the case where the memory balancer 122 receives a pseudo-physical that can be mapped, the memory balancer 122 maps a physical address to the pseudo-physical address. In the case where a physical address of physically embodied memory is mapped to a pseudo-physical address of a virtual machine, the virtual machine may be allocated with memory and use the physically embodied memory. Therefore, the memory balancer 122 may allocate or retrieve memory by the mapping or unmapping of a physical address to a pseudo-physical address of a virtual machine. Alternatively, the virtual machine monitor 120 may directly receive a pseudo-physical address, transmit capacity of memory, and map/unmap a physical address to/from the pseudo-physical address without using a memory balancer 122.

The storage 123 stores memory management information received previously, conditions for a victim virtual machine that needs memory retrieved and conditions for a beneficiary virtual machine that needs memory allocated. When receiving memory management information, the virtual machine selector 121 compares the received memory management information with prestored memory management information and calculates a changed amount, and then determines whether or not the virtual machine is a victim virtual machine or whether or not the virtual machine is a beneficiary virtual machine based on whether or not the memory management information and the changed amount satisfy the conditions for the victim virtual machine and the conditions for the beneficiary virtual machine, respectively.

The storage 123 stores the received memory management information for a certain period of time, and regarding the case where the virtual machine selector 121 calculates the changed amount of the memory management information, the memory management information being provided to the virtual machine selector 121 is memory management information received (prereceived) within a certain period of time. Furthermore, the virtual machine monitor 120 may include a separate storage 123 that is not included in the virtual machine selector 121.

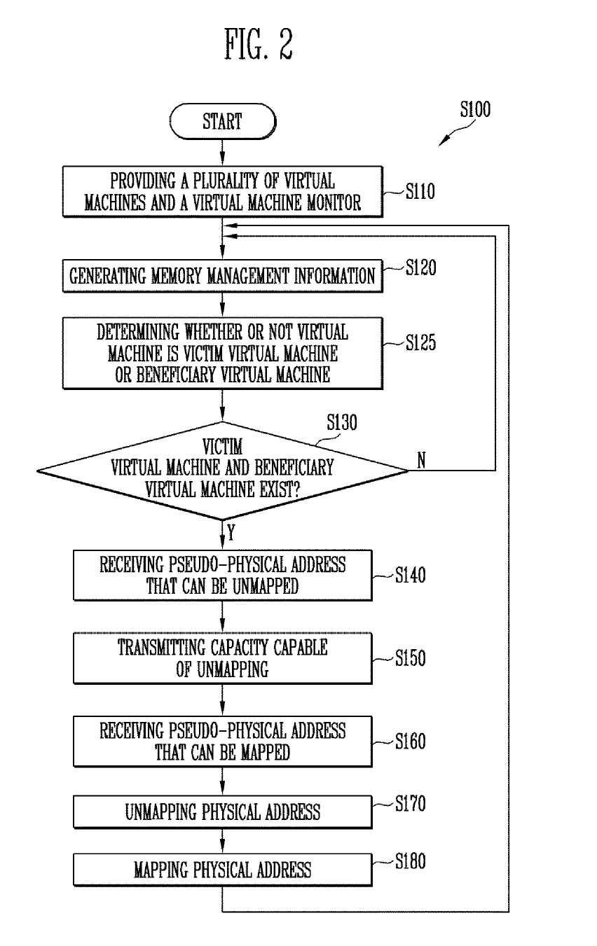

FIG. 2 is a flowchart illustrating a method for driving a virtual machine according to an embodiment of the present invention. Referring to FIG. 2, the method for driving a virtual machine S100 includes a step of providing a plurality of virtual machines and a virtual machine monitor S110, step of generating memory management information S120, step of determining whether or not a virtual machine is a victim virtual machine or whether or not the virtual machine is a beneficiary virtual machine S125, step S130, step of receiving a pseudo-physical address that can be unmapped S140, step of transmitting capacity capable of performing an unmapping S150, step of receiving a pseudo-physical address that can be mapped S160, step of unmapping a physical address S170, and step of mapping a physical address S180. Hereinafter, steps S110, S120, S125, S130, S140, S150, S160, S170, and S180 will be explained with reference to FIGS. 1 and 2.

At the step of providing a plurality of virtual machines and a virtual machine monitor S110, virtual machines, 110-1 to 110-n, that include virtual machine information managers, 111-1 to 111-n, respectively, and memory reclaimers/allocators, 112-1 to 112-n; respectively; and a virtual machine monitor 120 that includes a virtual machine selector 121, memory balancer 122, and storage 123 are provided.

At the step of generating memory management information S120, at least some of the virtual machine information managers, 111-1 to 111-n, generate memory management information.

At the step of determining whether or not a virtual machine is a victim virtual machine or whether or not a virtual machine is a beneficiary virtual machine S125, the virtual machine selector 121 receives the memory management information, and determines whether or not each of the virtual machines, 110-1 to 110-n, is a victim machine or a beneficiary virtual machine based on the received memory management information.

At step S130, if it is determined that there exists a victim virtual machine and a beneficiary virtual machine, the virtual machine monitor 120 determines that it is necessary to retrieve at least a portion of the memory that had been allocated to the victim virtual machines and allocate the memory to the beneficiary virtual machine, and performs the step of receiving a pseudo-physical address that can be unmapped S140, but if it is determined that there does not exist a victim virtual machine and a beneficiary virtual machine, the virtual machine monitor 120 performs the step of generating memory management information S120. Hereinafter, steps S140, S150, S160, S170, and S180 will be explained based on an assumption that virtual machine 1 (see reference numeral 110-1 in FIG. 1) is a victim virtual machine, and virtual machine 2(see reference numeral 110-2 in FIG. 1) is a beneficiary virtual machine, for convenience.

At the step of receiving a pseudo-physical address that can be unmapped S140, the virtual machine 1 determines a pseudo-physical address that can be unmapped, and the memory balancer 122 receives the pseudo-physical address that can be unmapped from the memory reclaimer/allocator 112-1. For convenience of transmitting/receiving addresses, the addresses may be bundled up in certain units (for example, 0X1000, 1000 as hexadecimal number) and then transmitted/received, wherein the number of a certain unit is referred to as a page frame number. For example, in the case of transmitting addresses from OX7000 to OX7FFF, page frame number 7 can be transmitted.

At the step of transmitting capacity capable of performing an unmapping S150, the memory balancer 122 computes the capacity capable of performing an unmapping based on the received pseudo-physical address that can be unmapped, and then transmits the capacity capable of performing an unmapping to the memory reclaimer/allocator 112-2 of virtual machine 2.

At the step of receiving a pseudo-physical address that can be mapped S160, the virtual machine 2 determines a pseudo-physical address that can be mapped based on the received capacity capable of performing an unmapping, and the memory balancer 122 receives the pseudo-physical address that can be mapped from the memory reclaimer/allocator 112-2 of the virtual machine 2.

At the step of unmapping a physical address S170, the memory balancer 122 unmaps a physical address from the pseudo-physical address that can be unmapped. When this step is performed, a portion of the memory that had been allocated to the virtual machine 1 is retrieved.

At the step of mapping a physical address S180, the memory balancer 122 maps a physical address to the pseudo-physical address that can be mapped. When this step is performed, the virtual machine 2 is allocated with memory.

In FIG. 2, it is illustrated that the step of receiving a pseudo-physical address that can be unmapped S140 is performed first, followed by the step of transmitting capacity capable of performing an unmapping S150, followed by the step of receiving a pseudo-physical address that can be mapped S160, followed by the step of unmapping a physical address S170, followed by the step of mapping a physical address S180, but alternatively, the step of receiving a pseudo-physical address that can be mapped S140 may be performed first, followed by the step of unmapping a physical address S170, followed by the step of transmitting capacity capable of performing an unmapping S150, followed by the step of receiving a pseudo-physical address that can be mapped S160, followed by the step of mapping a physical address S180.

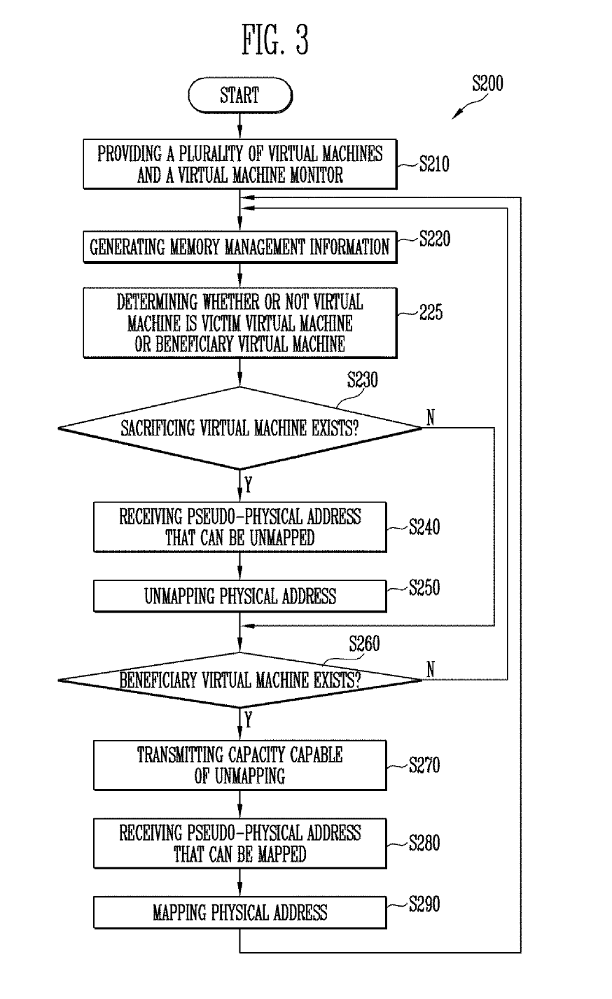

FIG. 3 is a flowchart illustrating a method for driving a virtual machine according to another embodiment of the present invention. Referring to FIG. 3, a method for driving a virtual machine S200 includes a step of providing a plurality of virtual machines and a virtual machine monitor S210, generating memory management information S220, step of determining whether or not a virtual machine is a victim virtual machine or whether or not the virtual machine is a beneficiary virtual machine S225, step S230, step of receiving a pseudo-physical address that can be unmapped S240, step of unmapping a physical address S250, step S260, step of transmitting capacity capable of performing an unmapping S270, step of receiving a pseudo-physical address that can be mapped S280, and step of mapping a physical address S290. The step of providing a plurality of virtual machines and a virtual machine monitor S210, the step of generating memory management information S220, the step of determining whether or not a virtual machine is a victim virtual machine or whether or not the virtual machine is a beneficiary virtual machine S225, the step of receiving a pseudo-physical address that can be unmapped S240, the step of unmapping a physical address S250, the step of transmitting capacity capable of performing an unmapping S270, the step of receiving a pseudo-physical address that can be mapped S280, and the step of mapping a physical address S290 correspond to the step of providing a plurality of virtual machines and a virtual machine monitor S110, the step of generating memory management information S120, the step of determining whether or not a virtual machine is a victim virtual machine or whether or not the virtual machine is a beneficiary virtual machine S125, the step of receiving a pseudo-physical address that can be unmapped S140, the step of unmapping a physical address S170, the step of transmitting capacity capable of performing an unmapping S150, the step of receiving a pseudo-physical address that can be mapped S160, and the step of mapping a physical address S180 illustrated in FIG. 2, respectively, and thus detailed explanation is omitted. Hereinafter, each of the steps S230, S260, S270, S280, and S290 will be explained with reference to FIGS. 1 and 3.

At step S230, if there exists a victim virtual machine, the step of unmapping a pseudo-physical address that can be mapped may be performed S240, whereas if there does not exist a victim virtual machine, step S260 is performed. In the method for driving a virtual machine S100 illustrated in FIG. 2, if there exists a victim virtual machine only, the step of generating memory management information S120 is performed, but in the method for driving a virtual machine S200, the step of receiving a pseudo-physical address that can be mapped S240 and the step of unmapping a physical address S250 are performed even if there exists a victim virtual machine only. At step S240 and step S250, a pseudo-physical address that can be unmapped is stored in the memory balancer 122.

At step S260, if there exists a beneficiary virtual machine, the step of transmitting capacity capable of performing an unmapping S270 is performed, but if there does not exist a beneficiary virtual machine, the step of generating memory management information S220 is performed. In the method for driving a virtual machine S100 illustrated in FIG. 2, if there exists a beneficiary virtual machine only, the step of generating memory management information S120 is performed, but in the method for driving a virtual machine S200, steps S270, S280, and S290 are performed even if there exists a beneficiary virtual machine only. Although not illustrated in FIG. 3, when the step of unmapping a physical address S250 is not performed because there is no victim virtual machine and there is no pseudo-physical address that can be unmapped stored the memory balancer 122, steps S270, S280, and S290 cannot be performed. The virtual machine monitor 120 may output a warning message to a user through an interface (not illustrated), and may notify lack of memory to the virtual machines, 110-1 to 110-n, while also requesting that the virtual machines, 110-1 to 110-n, restrict or stop the processes that they had been performing.

At the step of transmitting capacity capable of performing an unmapping S270, the memory balancer 122 computes capacity capable of performing an unmapping based on the pseudo-physical addresses that can be unmapped stored every time step S240 and step S250 were performed, and transmits the capacity capable of performing an unmapping to the memory reclaimer/allocator of a beneficiary virtual machine.

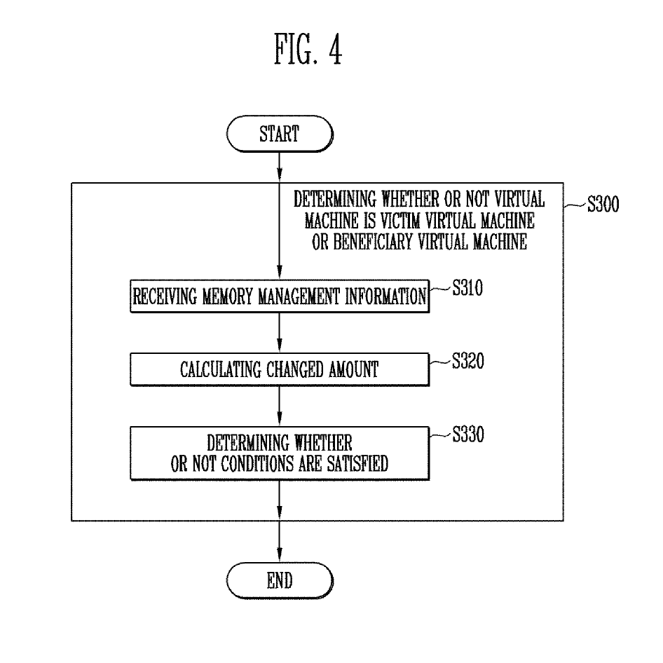

FIG. 4 is a view illustrating a step of determining whether or not a virtual machine is a victim virtual machine or whether or not a virtual machine is a beneficial virtual machine according to another embodiment of the present invention. A step of determining whether or not a virtual machine is a victim virtual machine or whether or not a virtual machine is a beneficial virtual machine S300 corresponds to step S125 or step S225, and hereinafter this step will be explained in detail with reference to FIGS. 1 to 4.

At a step of receiving memory management information S310, the virtual machine selector 121 receives memory management information generated by virtual machine information managers, 111-1 to 111-n. The memory management information received is stored in the storage 123 for a certain period of time.

At a step of calculating a changed amount S320, the changed amount may be calculated by comparing the memory management information stored in the storage with the memory management information received at step S310. The calculated changed amount may be stored in the storage 123.

At a step of determining whether or not certain conditions are satisfied S330, the virtual machine selector 121 determines whether or not a virtual machine is a victim virtual machine and whether or not the virtual machine is a beneficiary virtual machine based on whether or not the memory management information received at step S310 and the changed amount calculated at step S320 satisfy conditions for the victim virtual machine and conditions for the beneficiary virtual machine stored in the storage 123, respectively.

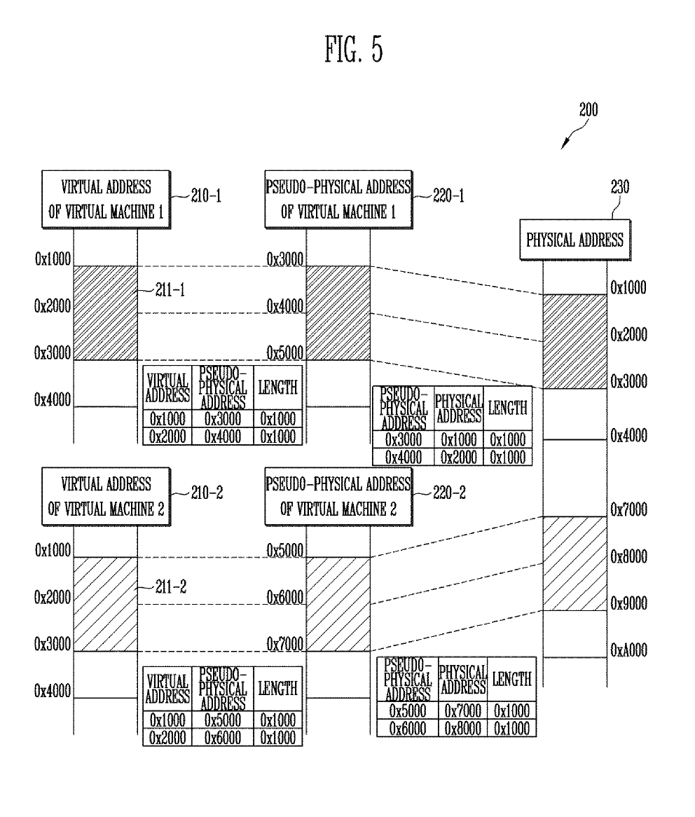

FIGS. 5 to 8 are views illustrating mapping of a virtual address, pseudo-physical address, and physical address when using a method for driving a virtual machine according to another embodiment of the present invention. Hereinafter, explanation will be made with reference to FIGS. 1 to 4. Mapping of pseudo-physical addresses, 220-1 and 220-2, to virtual addresses, 210-1 and 210-2, is managed by a guest OS that uses the virtual machines, 110-1 and 110-2, and mapping of a physical address 230 to pseudo-physical addresses, 220-1 and 220-2, is managed by the virtual machine monitor 120.

FIG. 5 is a view illustrating after the guest OS using the virtual machine 1 and the guest OS using the virtual machine 2 are booted. Referring to FIG. 5, of the virtual address 210-1 of the virtual machine 1, the usage area 211-1 is from OX1000 to OX2FFF (page frame number 1, 2), and are mapped to page frame number 3, 4 of the pseudo-physical address 220-1. The page frame number 3, 4 of the pseudo-physical address 220-1 are mapped to page frame number 1, 2 of the physical address 230. Likewise, of the virtual address 210-2 of the virtual machine 2, the usage area 211-2 is from OX1000 to OX2FFF (page frame number 1, 2), and are mapped to the page frame number 5, 6 of the pseudo-physical address 220-2. The page frame number 5, 6 of the pseudo-physical address 220-2 are mapped to the page frame number 7, 8 of the physical address 230. For booting, memory of the same capacity (OX2000) is allocated to the two virtual machines, 110-1 and 110-2.

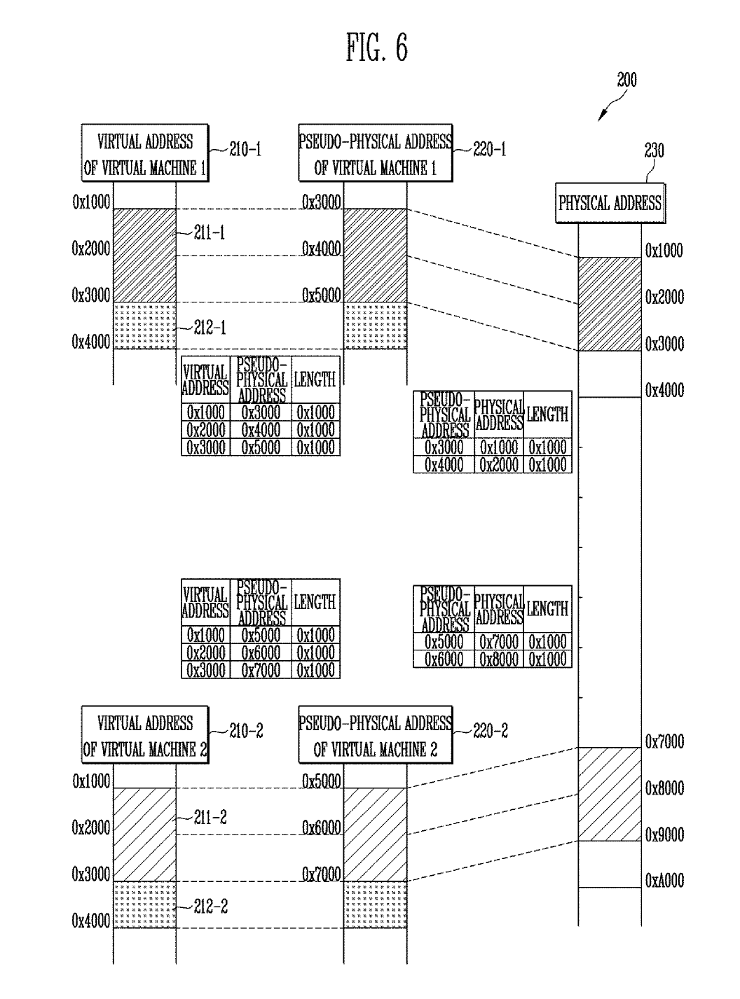

FIG. 6 is a view illustrating after ballooning is applied to the virtual machine 1 and virtual machine 2. Referring to FIG. 6, the virtual address, 210-1 and 210-2, include the usage area 211-1 and 211-2, and the balloon area, 212-1 and 212-2, respectively. The usage area, 211-1 and 211-2, may be mapped to the physical address 230 and then actually be used by a guest OS that uses the virtual machine 1 or a guest OS that uses the virtual machine 2, but the balloon area, 212-1 and 212-2, are not mapped to the physical address 230 and thus cannot actually be used. Mapping of the usage area, 211-1 and 211-2, is the same as in FIG. 5, and thus explanation thereof is omitted. The page frame number of the balloon area 212-1 is 3, and is mapped to page frame number 5 of the pseudo-physical address 220-1. However, in the case of the balloon area 212-2, the page frame number is 3, and is mapped to page frame number 7 of the pseudo-physical address 220-2. However, page frame number 5 of the pseudo-physical address 220-1 and page frame number 7 of the pseudo-physical address 220-2 are not mapped to the physical address 230, and thus cannot be used. The amount of memory that can be used by the guest OS may be adjusted by changing the sizes of the balloon area, 212-1 and 212-2.

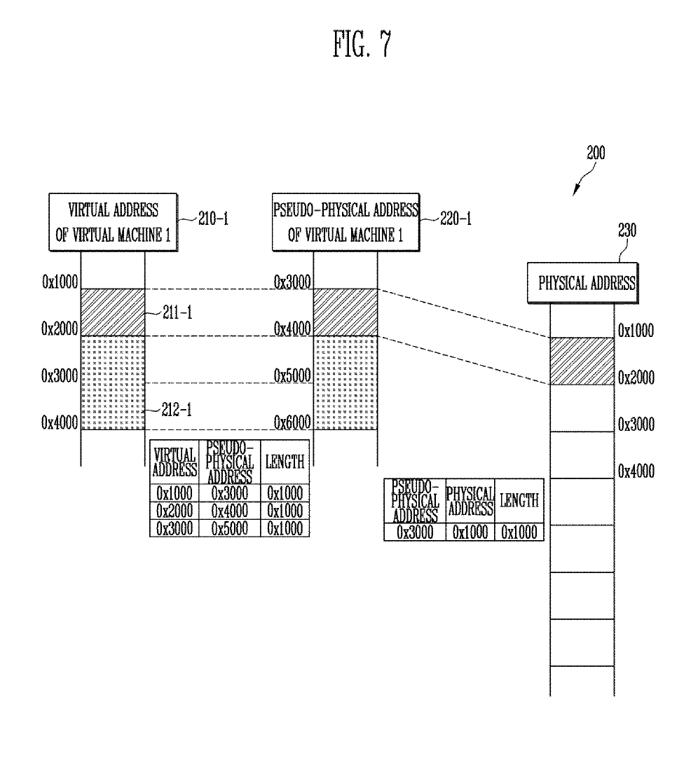

FIG. 7 is a view in the case of reclaiming the memory that had been allocated to the virtual machine 1. When it is determined at step 5225 that a victim virtual machine and beneficiary virtual machine exist, or when it is determined at step S225 that a victim virtual machine exists, steps S140 and S170 or steps S240 and S250 are performed. Hereinafter, assume that the virtual machine 1 is a victim virtual machine.

At the step of receiving a pseudo-physical address that can be unmapped, S140 or S240, the virtual machine 1 determines a pseudo-physical address that can be unmapped and transmits the pseudo-physical address that can be unmapped to the memory balancer 122. In FIG. 7, the pseudo-physical address that can be unmapped is determined to be from OX4000 to OX4FFF.

At the step of unmapping a physical address, S170 or S250, the memory balancer 122 unmaps a physical address from the pseudo-physical address that can be unmapped. Since page frame number 4 of the pseudo-physical address 220-1 is no longer mapped to page frame number 2 of the physical address 230 anymore, of the pseudo-physical address 220-1, only page frame number 3 is mapped to page frame number 1 of the physical address 230. Since page frame number 2 of the virtual address 210-1 is classified as a balloon area, the capacity of the usage area 211-1 decreased while the capacity of the balloon area 212-1 increased.

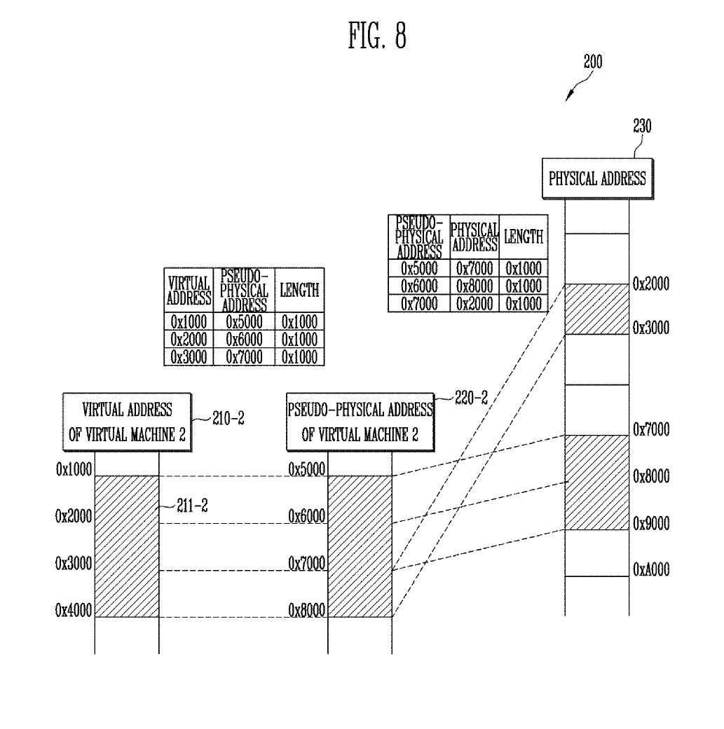

FIG. 8 is a view in the case of allocating memory to the virtual machine 2. When it is determined at step S125 that a victim virtual machine and a beneficiary virtual machine exist, or when it is determined at step S225 that a beneficiary virtual machine exists, steps S150, S160, and S180 or steps S270, S280, and S290 are performed. The virtual machine 1 is a victim virtual machine, and the virtual machine 2 is a beneficiary virtual machine. Furthermore, as illustrated in FIG. 7, assume that steps S140 and S170 or steps S240 and S250 have been performed.

At the step of transmitting capacity capable of performing an unmapping, S150 and S270, the memory balancer 122 computes the capacity capable of performing an unmapping based on the pseudo-physical address that can be unmapped. Referring to FIGS. 7 and 8, the capacity capable of performing an unmapping is OX1000 (4096 in decimal system). The capacity capable of performing an unmapping is transmitted to the memory reclaimer/allocator 112-2 of the virtual machine 2.

At the step of receiving a pseudo-physical address that can be mapped, S160 and S280, the virtual machine 2 determines a pseudo-physical address that can be mapped based on the capacity capable of performing an unmapping received. In FIG. 8, the pseudo-physical address 220-2 that can be mapped is determined to be from OX7000 to OX7FFF. The memory balancer 122 receives the pseudo-physical address that can be mapped from the memory reclaimer/allocator 112-2 of the virtual machine 2.

At the step of mapping a physical address, S180 and S290, the memory balancer 122 maps a physical address to the pseudo-physical address that can be mapped. In FIG. 8, page frame number 7 of the pseudo-physical address 220-2 is mapped to page frame 2 of the physical address 230. Herein, the physical address being mapped at steps S180 and S290 (page frame 2 of physical address 230) is the physical address that used to be mapped to the pseudo-physical address of step S140 and S240 of receiving a pseudo-physical address that can be unmapped. Page frame numbers 5, 6, and 7 of the pseudo-physical address 220-2 are mapped to page frame numbers 7, 8, and 2 of the physical address 230, respectively. Since page frame number 3 is classified as a usage area, the capacity of the usage area 211-2 increased and the capacity of the balloon area 212-2 decreased to 0.

In the drawings and specification, there have been disclosed typical exemplary embodiments of the invention, and although specific terms are employed, they are used in a generic and descriptive sense only and not for purposes of limitation. As for the scope of the invention, it is to be set forth in the following claims. Therefore, it will be understood by those of ordinary skill in the art that various changes in form and details may be made therein without departing from the spirit and scope of the present invention as defined by the following claims.

What is claimed is:

1. A method for driving a virtual machine, the method comprising:
providing a plurality of virtual machines and a virtual machine monitor configured to manage the plurality of virtual machines;
generating, by the plurality of virtual machines, memory management information, that is information on memory being used by the plurality of virtual machines; and
determining, by the virtual machine monitor, whether or not a virtual machine is a victim virtual machine from which memory needs to be retrieved or whether or not the virtual machine is a beneficiary virtual machine where memory needs to be allocated, based on the memory management information.

2. The method according to claim 1,
wherein the providing of a plurality of virtual machines and a virtual machine monitor comprises allocating or reclaiming memory by mapping or unmapping a physical address to or from a pseudo-physical address of a virtual machine, each virtual machine transmitting a pseudo-physical address of the virtual machine to the virtual machine monitor.

3. The method according to claim 2,
wherein in response to it being determined that there exists a victim virtual machine and a beneficiary virtual machine as a result of the determining of whether or not a virtual machine is a victim virtual machine or whether or not the virtual machine is a beneficiary virtual machine, the method further comprises:
receiving, by the virtual machine monitor, a pseudo-physical address that can be unmapped from the victim virtual machine;
transmitting, by the virtual machine monitor, capacity capable of performing an unmapping to the beneficiary virtual machine;
receiving, by the virtual machine monitor, a pseudo-physical address that can be mapped from the beneficiary virtual machine;
unmapping, by the virtual machine monitor, a physical address from the pseudo-physical address that can be unmapped; and
mapping, by the virtual machine monitor, a physical address to the pseudo-physical address that can be mapped.

4. The method according to claim 2,
wherein in response to it being determined that there exists a victim virtual machine as a result of the determining of whether or not a virtual machine is a victim virtual machine or whether or not the virtual machine is a beneficiary virtual machine, the method further comprises:
receiving, by the virtual machine monitor, a pseudo-physical address that can be unmapped from the victim virtual machine; and
unmapping, by the virtual machine monitor, a physical address from the pseudo-physical address that can be unmapped.

5. The method according to claim 4,
wherein in response to it being determined that there exists a beneficiary virtual machine as a result of the determining of whether or not a virtual machine is a victim virtual machine or whether or not the virtual machine is a beneficiary virtual machine, the method further comprises:
transmitting, by the virtual machine monitor, capacity capable of performing an unmapping to the beneficiary virtual machine;
receiving, by the virtual machine monitor, a pseudo-physical address that can be mapped from the beneficiary virtual machine; and
mapping, by the virtual machine monitor, a physical address to the pseudo-physical address that can be mapped.

6. The method according to claim 3,
wherein physical addresses mapped to the pseudo-physical addresses that can be mapped at the mapping of a physical address to the pseudo-physical address that can be mapped comprises at least some of the physical addresses that used to be mapped to the pseudo-physical addresses that can be unmapped.

7. The method according to claim 5,
wherein physical addresses mapped to the pseudo-physical addresses that can be mapped at the mapping of a physical address to the pseudo-physical address that can be mapped comprises at least some of the physical addresses that used to be mapped to the pseudo-physical addresses that can be unmapped.

8. The method according to claim 1,
wherein the determining of whether or not a virtual machine is a victim virtual machine or whether or not the virtual machine is a beneficiary virtual machine comprises:
the generating of memory management information;
calculating a changed amount by comparing the memory management information and prestored memory management information; and
determining whether each virtual machine satisfies conditions for a victim virtual machine prestored or conditions for a beneficiary virtual machine prestored based on the memory management information and the changed amount.

9. The method according to claim 1,
wherein at the generating of memory management information,
the memory management information comprises at least one of the capacity of a pseudo-physical memory, usage rate of a pseudo-physical memory, capacity of memory that can be unmapped, size of a working set, and space usage rate of a swap device of each virtual machine.

10. A system for driving a virtual machine, the system comprising: a plurality of virtual machines, each having a virtual machine information manager; and a virtual machine monitor configured to manage the plurality of virtual machines and having a virtual machine selector,
wherein memory management information on the memory used by each virtual machine is generated by the virtual machine information manager, and the virtual machine selector determines whether or not a virtual machine is a victim virtual machine from which memory needs to be retrieved or whether or not the virtual machine is a beneficiary virtual machine to which memory needs to be allocated.

11. The system according to claim 10,
wherein the virtual machine monitor further comprises a memory balancer configured to allocate or retrieve memory by mapping or unmapping a physical address to or from a pseudo-physical address of a virtual machine, and a memory/allocator configured to transmit a pseudo-physical address of each virtual machine to the memory balancer.

12. The system according to claim 11,
wherein in response to there existing a victim virtual machine and a beneficiary virtual machine,
the virtual machine monitor receives a pseudo-physical address that can be unmapped from a memory reclaimer/allocator of the victim virtual machine,
transmits the capacity capable of performing an unmapping to a memory reclaimer/allocator of the beneficiary virtual machine, and
receives a pseudo-physical address that can be mapped from the memory reclaimer/allocator of the beneficiary virtual machine.

13. The system according to claim 12,
wherein the memory balancer unmaps a physical address from the pseudo-physical address that can be unmapped; and
maps the physical address to a pseudo-physical address that can be mapped.

14. The system according to claim 11,
wherein in response to there existing a victim virtual machine,
the virtual machine monitor receives a pseudo-physical address that can be unmapped from the memory reclaimer/allocator of the victim virtual machine, and
the memory balancer unmaps a physical address from the pseudo-physical address that can be unmapped.

15. The system according to claim 14,
wherein in response to there existing a beneficiary virtual machine,
the virtual machine monitor transmits the capacity capable of performing an unmapping to a memory reclaimer/allocator of the beneficiary virtual machine, and receives a pseudo-physical address that can be mapped from the memory reclaimer/allocator of the beneficiary virtual machine, and
the memory balancer maps a physical address to the pseudo-physical address that can be mapped.

16. The system according to claim 13,
wherein physical addresses mapped to the pseudo-physical addresses that can be mapped comprises at least some of the physical addresses that used to be mapped to the pseudo-physical addresses that can be unmapped.

17. The system according to claim 15,
wherein physical addresses mapped to the pseudo-physical addresses that can be mapped comprises at least some of the physical addresses that used to be mapped to the pseudo-physical addresses that can be unmapped.

18. The system according to claim 10,
wherein the virtual machine monitor further comprises a storage configured to store memory management information received previously, conditions for a victim virtual machine, and conditions for a beneficiary virtual machine,
the virtual machine selector, in response to receiving the memory management information, calculates a changed amount by comparing the received memory management information with the memory management information prestored in the storage, and
determines whether or not a virtual machine is a victim virtual machine and whether or not the virtual machine is a beneficiary virtual machine based on whether or not the memory management information and the changed amount satisfy the conditions for the victim virtual machine and the conditions for the beneficiary virtual machine, respectively.

19. The system according to claim 10,
wherein the memory management information comprises at least one of the capacity of a pseudo-physical memory, usage rate of the pseudo-physical memory, capacity of the memory that can be unmapped, size of a working set, and space usage rate of a swap device of each virtual machine.
